(19) United States
(12) Patent Application Publication
(10) Pub. No.: US 2003/0012232 A1
(43) Pub. Date: Jan. 16, 2003

(54) Multi-wavelength switchable laser

(75) Inventor: Robert W. Musk, Kingsbridge (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA

(21) Appl. No.: 10/134,128

(22) Filed: Apr. 29, 2002

Related U.S. Application Data
(60) Provisional application No. 60/286,975, filed on Apr. 30, 2001.

(51) Int. Cl. H01S 3/10; H01S 3/08

(52) U.S. Cl. 372/23; 372/96; 372/92; 372/21

(57) ABSTRACT

A multi-wavelength switchable laser system configured at known wavelengths without the need for wavelength feedback/locking control. The system includes an optical gain element, e.g. a pump source; a laser cavity defined by electrically activated Bragg gratings, each having a prescribed operational wavelength; a control module for controlling actuation of the gratings to activate a selected one of the gratings for operation at a selected operational wavelength; and an appropriate lens for removing an output signal at the selected operational wavelength from the laser cavity to a fiber.

### RELATED APPLICATIONS

This application claims priority from U.S. Provisional application No. 60/286,975 filed Apr. 30, 2001.

### BACKGROUND OF INVENTION

The present invention relates to the field of multi-wavelength switchable laser sources.

Multi-wavelength switchable lasers have applications in many fields, including optical communications and spectroscopy. Modulation and switching of optical signals are basic functions in an optical communication system. Through modulation, the information to be communicated is expressed in one or more parameters of a light signal, such as the amplitude, the polarization, the phase or frequency of the field, or of the magnitude or spatial distribution of the power and/or intensity. Through switching, the light signal may be routed through a network of optical nodes and connections.

Multi-wavelength switchable lasers are required for applications in WDM/DWDM (wavelength division multiplexed and dense WDM) based fiber optic communication systems. DWDM was developed as a way to maximize the capacity of the existing fiber optic infrastructure. Initial fiber optic technology enabled only one wavelength to be transported over fiber, DWDM technology is based on the use of varying wavelengths to conduct groups of signals over the same fiber.

Key requirements for multi-wavelength switchable laser sources for WDM/DWDM systems include: (a) an accurate match with the wavelength channels on the WDM/DWDM ITU grid; (b) an arbitrary set of such channels; (c) a capability for switching reliably to any channel between such a pre-selected arbitrary set of channels; (d) low cross talk and (e) microsecond (or faster) switching speeds. The term “ITU grid” refers to a standard grid of WDM channels: in particular, discrete set of pre-designated wavelengths that are (a) used as optical carriers of information (i.e., wavelength channels separated by 100 GHz in the ITU DWDM grid); or (b) used as signals for the control, generation, routing, and supervision of the above-mentioned optical carrier wavelength channels.

Past multi-wavelength switchable laser sources have, in general, been limited to schemes that are either difficult to scale to a large number of wavelengths, or have relatively slow (millisecond) switching speeds. Further, many conventional multi-wavelength switchable laser arrangements require the use of stable external “wavelength lockers” to prevent wavelength drift from the FFPs PZT (fiber Fabry Perot filters) tuning assembly. Multi-frequency lasers based on integrated-optic arrays of DBR (distributed Bragg reflector) and DFB (distributed feedback) lasers, or SOA (semiconductor optical amplifier) arrays integrated with AWGs (arrayed waveguide gratings) may satisfy some of the above requirements. However, these solutions remain relatively difficult and expensive to manufacture, particularly in small volumes or for custom applications that may require a combination of numerous arbitrarily spaced channels on the WDM/DWDM ITU grid.

### SUMMARY OF INVENTION

An object of the present invention is to provide a multi-wavelength switchable laser system with improved switching speed between a plurality of wavelengths.

In an exemplary embodiment, the present invention provides a multi-wavelength switchable laser system whose fundamental wavelength can be rapidly switched to any of a number of pre-set wavelengths without the need for external wavelength locking to control the laser system.

In a further exemplary embodiment, the present invention provides a multi-wavelength switchable laser system that uses electrically activated Bragg gratings in a concatenated arrangement where the gratings are transparent when inactive. As a result, any applicable (i.e., is available in one of the gratings) wavelength can be individually selected.

In accordance with one aspect of the present invention there is provided a multi-wavelength switchable laser system comprising: an optical gain element, e.g. a pump source; a laser cavity is communication with the gain element; a plurality of electrically activated Bragg gratings, each having a prescribed operational wavelength, disposed in the laser cavity; means for controlling actuation of the electrically activated Bragg gratings to activate a selected one of the electrically activated Bragg gratings for operation at a selected operational wavelength and means for removing an output signal at the selected operational wavelength from the laser cavity. The optical gain element (pump source) may be a semiconductor gain element.

Other aspects and features of the present invention will become apparent to those ordinarily skilled in the art upon review of the following description of specific embodiments of the invention in conjunction with the accompanying figures.

### BRIEF DESCRIPTION OF DRAWINGS

Further features and advantages of the present invention will be described in the detailed description, taken in combination with the appended drawings, in which:

FIG. 1 illustrates a general block diagram representation of a multi-wavelength switchable laser system according to one embodiment of the present invention; and

FIG. 2 illustrates a general block diagram representation of a multi-wavelength switchable laser system according to another embodiment of the present invention,

FIG. 3 illustrates an embodiment of the invention in which the gratings are formed by a liquid crystal material, and

FIG. 4 illustrates another embodiment of the invention.

### DETAILED DESCRIPTION

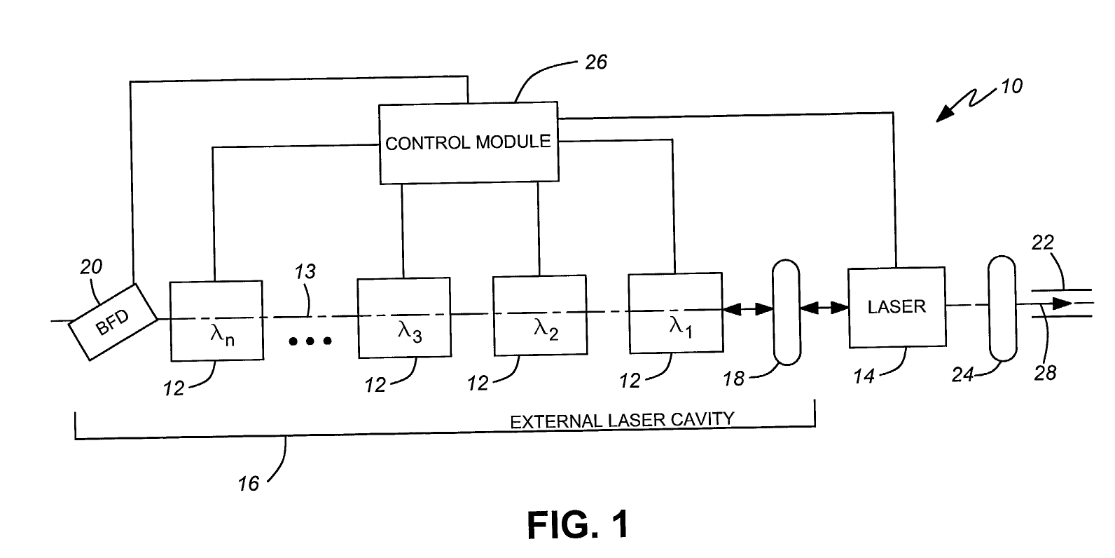

FIG. 1 illustrates a multi-wavelength switchable laser system 10 according to an embodiment of the present invention. A plurality of electrically activated Bragg gratings 12, having a plurality of prescribed operational wavelengths λ₁ . . . λₙ (discussed in more detail below), are arranged behind a laser/pump source 14 on an axis of propagation 13 to create a portion of an external laser cavity 16. A lens 18 (e.g. an AR (anti-reflection) coated lens) is arranged within the laser cavity 16, at one end of the group of gratings 12, to collimate light (i.e., adjust two or more optical axes with respect to each other).

A back facet detector (BFD) 20 is also arranged within the laser cavity 16, at the other end of the group of gratings 12, to provide a mechanism of feedback control for the laser source 14 to control optical power launched into a fiber 22 through a focusing lens 24, arranged in front of the laser source 14, to focus light to create an output signal 28 into the fiber 22. A control module 26 is provided to control the operation of the gratings 12, the BFD 20 and the laser source 14. More specifically, the control module 26 is a means for controlling the actuation of the gratings 12 to activate various wavelengths as discussed further below.

The term “external laser cavity” refers to a round trip path for an optical field of the laser 14. This propagation of the optical field in the roundtrip path may be facilitated by various means that include, but are not limited to, fiber-optic waveguides, planar waveguides in bulk glass, planar waveguides in semiconductors, etc.

The term “laser/pump source” refers to an optical or electrically tunable or switchable emission. An example of a suitable laser source is a Fabry Perot laser with a facet AR coated end.

Generally, a grating refers to a structure containing alternating periodic segment arms of varying periods of high and low refractive index material segment arms and/or appropriately embedded phase shift segment arms at well defined locations of the structure. In an exemplary embodiment, the gratings 12 are electrically activated Bragg grating crystals, that include an electroholographic crystal component.

Well known to those skilled in the art, electroholography is a beam stirring method based on reconstructing volume holograms by means of an externally applied electric field. Electroholography exploits the voltage controlled photorefractive effect at the paraelectric phase. Volume holograms stored as a spatial distribution of space charge in a paraelectric crystal can be reconstructed by the application of an electrical field to the crystal. This field activates pre-stored holograms, which determine the routing of light beams.

Electroholographic technology is used to write a wavelength-specific hologram, the Bragg gratings 12, into a potassium lithium tantalate niobate (KLTN) crystal for example. Each of the Bragg gratings 12 is designed to reflect a specific wavelength of light (i.e., one of λ₁ . . . λₙ). For example, if there are three wavelengths (e.g., red, green and yellow) transmitting through a selected one of the gratings 12 and the selected gratings is written for the green wavelength, then the yellow and red pass through unaffected. Further, even though the selected grating was written for the green wavelength, the green passes through the selected grating unaffected, as well. When voltage is applied, from the control module 26 for example, the green is deflected because the selected grating becomes active.

Therefore, the plurality of gratings 12, each created with a unique wavelength-specific hologram, enable the system 10 to operate at any of the wavelengths λ₁ . . . λₙ by electronically activating a selected grating 12 using the control module 26. The wavelength (one of λ₁ . . . λₙ) feeding the fiber 22 is stabilized at the wavelength of the grating 12 and does not require external monitoring for wavelength since the grating wavelength in the grating 12 is fixed when created as discussed above. The other gratings 12 that remain inactive (i.e., not electrically activated) do not affect light passing through them.

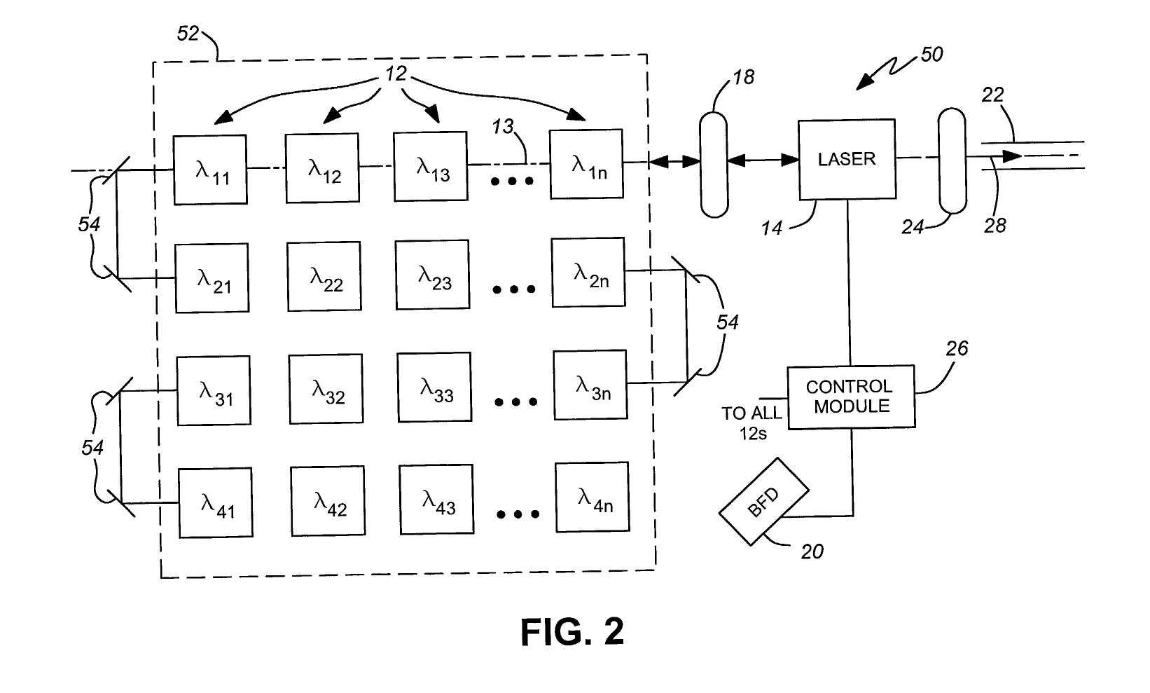

FIG. 2 illustrates a multi-wavelength switchable laser system 50 according to another embodiment of the present invention. In system 50, the external cavity 16 includes a 2-dimensional matrix 52 of gratings 12. The other elements of the system 50: the control module 26, the BFD 20, the lenses 18 and 24, the laser source 14 and the fiber 22 operate in the same manner as discussed in conjunction with FIG. 1. By using the 2-dimensional matrix configuration 52, many more wavelength options (channels) can be provided for the system 50, each with a unique wavelength λ₁₁ . . . λ₄ₙ. The gratings 12 in each row of the matrix 52 are aligned with the propagation axis 13 (only one shown in FIG. 2 for simplicity). Mirrors 54 are arranged to propagate light between rows in the matrix 52.

Alternatively, some or all of the electrically activated gratings can be formed in a liquid crystal material, for example by depositing the liquid crystal material over a substrate patterned with a Bragg grating.

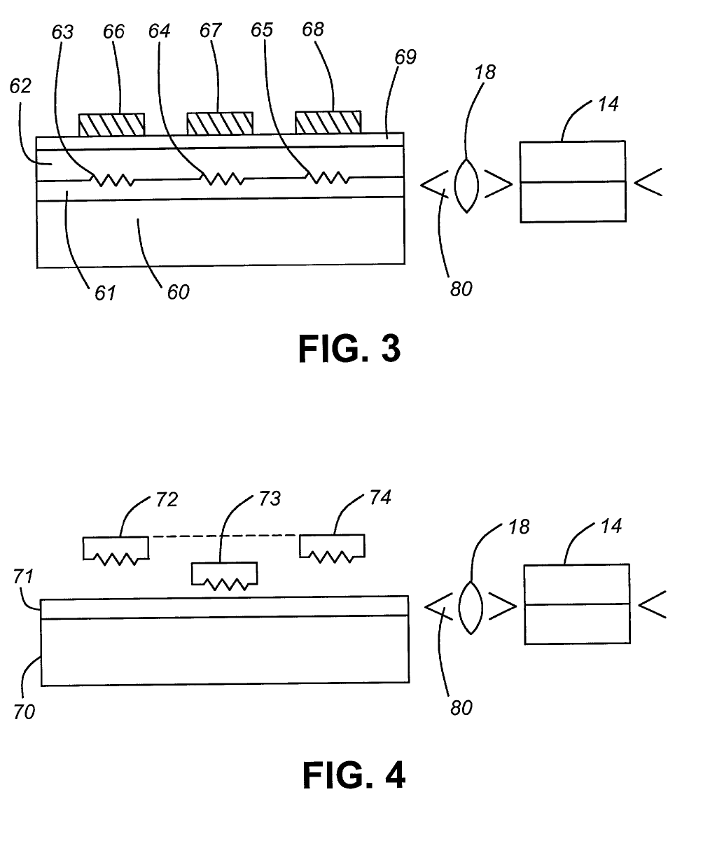

FIG. 3 discloses a third embodiment in which the electrically activated gratings are formed by a liquid crystal material. A waveguide layer 61 is formed on a substrate 60 and coupled by lens 18 to optical gain element 14. The waveguide layer is patterned with Bragg gratings 63, 64, 65 of two or more periods. A layer of liquid crystal 62 is deposited on top of the waveguide layer 61. The waveguide layer 61 may be treated to preferentially align the molecules of the liquid crystal layer 62 by means well known in the art. The liquid crystal layer 62 is covered by an encapsulant layer 69 and electrodes 66, 67, 68 are deposited thereon. The liquid crystal layer and the waveguide layer are selected so as to present the same refractive index to the optical field propagating within the waveguide 61, so that there is no reflectivity under a particular set of voltages applied to electrodes 66, 67, 68. In a preferred embodiment, there would be no reflectivity under zero voltage but other voltages may be used, i.e., it may be necessary to tune each voltage individually. When a voltage is applied, the index of refraction of the liquid crystal material changes and provides contrast with the index of the waveguide layer 61, thus activating the grating and providing reflectivity.

FIG. 4 discloses a fourth embodiment wherein the laser light 80 is optically coupled to a waveguide 71 formed on a substrate 70. Above the waveguide is suspended a plurality of gratings 72, 73, 74 formed in a material transparent to laser light 80. When electrically activated, the grating 72, 73, or 74 descends closer to the waveguide 71, so that the evanescent field of the light 80 propagating within waveguide 71 interacts with the activated grating. The mechanism that cause the selected grating to descend upon activation could be MEMS or other means well known in the art.

In summary, the present invention provides a multi-wavelength switchable laser system that uses electrically activated Bragg gratings that allows several gratings to be concatenated as they are transparent when inactive. Any wavelength can then be individually selected provided it is available in one of the gratings.

1. A multi-wavelength switchable laser system comprising:
(a) an optical gain element;
(b) a laser cavity, said optical gain element communicating with the laser cavity;
(c) a plurality of electrically activated Bragg gratings, each having a prescribed operational wavelength, disposed in the laser cavity;
(d) means for controlling actuation of the plurality of electrically activated Bragg gratings to activate a selected one of the plurality of electrically activated Bragg gratings for operation at a selected operational wavelength; and
(e) means for removing an output signal at the selected operational wavelength from the laser cavity.

2. The system of claim 1, further comprising a lens for collimating light from the gratings in the laser cavity.

3. The system of claim 1, further comprising a back facet detector arranged in the laser cavity for monitoring output from the optical gain element.

4. The system of claim 1, wherein the means for removing includes a focusing lens for focusing light to be received by a fiber.

5. The system of claim 1, wherein the optical gain element is a semiconductor gain element.

6. The system of claim 5, wherein the gain element is a Fabry-Perot laser that includes a facet anti-reflection coated end.

7. The system of claim 1, wherein at least some of the plurality of electrically activated Bragg gratings are arranged linearly with a longitudinal axis of the gratings being approximately parallel with a light propagation direction generated from the optical gain element.

8. The system of claim 7, wherein each of the Bragg gratings is written with the prescribed operational wavelength into a photorefractive crystal.

9. The system of claim 8 wherein the photorefractive crystal is potassium lithium tantalate niobate crystal.

10. The system of claim 7 wherein one or more of the Bragg gratings is formed at least partly in a liquid crystal material.

11. The system of claim 7 wherein said cavity incorporates a waveguide and one or more of the Bragg gratings is formed in a material adjacent to said waveguide, said means for controlling actuation being means for bringing said Bragg gratings into proximity with said waveguide.
